(19) United States
(12) Patent Application Publication
(10) Pub. No.: US 2018/0089429 A1
(43) Pub. Date: Mar. 29, 2018

(54) DERIVING A SECURITY PROFILE FOR SESSION-BASED SECURITY IN DATA CENTERS

(71) Applicant: Avocado Systems Inc., San Jose, CA (US)

(72) Inventor: Keshav Govind Kamble, San Jose, CA (US)

(21) Appl. No.: 15/275,239

(22) Filed: Sep. 23, 2016

(51) Int. Cl. G06F 21/56; G06F 21/55

(52) U.S. Cl. CPC G06F 21/562; G06F 21/552

(57) ABSTRACT

In one embodiment, a computer program product includes a computer readable storage medium having program instructions stored thereon. The program instructions are executable by a processing circuit to cause the processing circuit to obtain first scan results of a security threat scan of a first device using a first threat assessment application, obtain second scan results of a security threat scan of the first device using a second threat assessment application, combine the first scan results and the second scan results to produce a single security profile for the first device on a per session basis, manage actions of the first device in a session with a peer device based on the single security profile for the first device, and share the single security profile for the first device with other peer devices in a network on a per application and on the per session basis.

### FIELD OF THE INVENTION

The present invention relates to network and system protection, and more particularly, this invention relates to deriving a security profile for application and data security in data centers.

### BACKGROUND

Applications are made up of a large number of instructions and data. Instructions operate on data which is fetched in a cache and memory and is always unencrypted. Scaled-out, distributed applications are made up of a large number of application instances. These application instances have their own data in the cache and memory of the processor on which these applications run. A large number of such application instances communicate with each other and process data in parallel to create an aggregate output.

These types of scaled-out applications are extremely vulnerable to application breaches, data thefts from cache and memory by scraping, and other methods of illicitly obtaining data from the applications, cache, and/or memory. In data centers which cater to important applications and data types, such as Personally Identifiable Information (PII), Payment Card Industry (PCI) data, medical information that falls under Health Insurance Portability and Accountability Act (HIPAA), military and Government critical tasks, any application and/or data breach is very destructive and expensive to contain and/or resolve. Therefore, it is beneficial to attempt to prevent such breaches.

Typically, application security in data centers is attempted by applying policies and rules at various levels using security appliances installed in the data center. However, in spite of providing layers of security appliances to create a security perimeter around the data center, malware and malicious software still enters inside the servers in the data center to steal data and attack applications.

In most cases of data breaches, data and application instances that utilize flows in the East-West (E-W) direction, i.e., communication between servers and application instances inside of the data center, are attacked. This is different from North-South (N-S) flows which are protected by conventional data security appliances. Since the edge of the data center where all the servers are connected is considered the safest place, many times, applications communicate with each other in clear data without protecting the data. A huge amount of data is shared across applications and application tiers in the E-W direction within the data center.

End point protection agents (EPPAs), such as those produced by INTEL's MCAFEE, SYMANTEC, KAPERSKY, etc., run on end points, hosts, or servers and monitor local security of the host or server. Each EPPA provides security through various built-in mechanisms, e.g., firewalls, antivirus applications, signature matching, etc. They also look at every executable file downloaded on the host or server and attempt to protect the operating system's registry key database and other important configurations which are crucial for secure functioning of the host or server. As part of its functionality, the EPPA also scans the hard disk or other direct access storage device (DASD) to look for the presence of unexpected programs. Using all of the above processes, EPPAs prepare a comprehensive report and a conclusion about the host or server they are installed on. When any abnormality, exception, etc., is found on the host or server, the EPPA attempts to fix the problem or flags the issue to the host or server owner.

However, all the applications which are running on that host or server are completely unaware of the underlying security profile or situation of the host or server, as the EPPA does not report such information to the applications. Even though the EPPA may find multiple security anomalies and risks associated with the host or server, the applications keep on running as if it is completely safe to do so. Therefore, any confidential or sensitive data used by the applications is still kept on the host or server.

Moreover, the security situation of one host or server is not known to the any other host or server in a data center or cluster, and thus any scaled-out applications running on multiple hosts or servers are exposed to whatever is affecting the one host or server, such as malware, which may lead to widespread application and data breaches. Various applications which run on different hosts or servers in the data center and exchange sensitive data with each other do so without the awareness of the one server's security profile, thereby potentially losing important, sensitive information to malware, such as PII, PCI data, HIPPA records, etc.

### SUMMARY

In one embodiment, a method includes obtaining first scan results of a security threat scan of a first device using a first threat assessment application. The method also includes obtaining second scan results of a security threat scan of the first device using a second threat assessment application and combining the first scan results and the second scan results to produce a single security profile for the first device on a per session basis.

According to another embodiment, a system includes a processing circuit and logic integrated with and/or executable by the processing circuit. The logic is configured to cause the processing circuit to obtain first scan results of a security threat scan of a first device using a first threat assessment application. The logic is also configured to cause the processing circuit to obtain second scan results of a security threat scan of the first device using a second threat assessment application. Moreover, the logic is configured to cause the processing circuit to combine the first scan results and the second scan results to produce a single security profile for the first device on a per session basis.

In yet another embodiment, a computer program product includes a computer readable storage medium having program instructions stored thereon. The program instructions are executable by a processing circuit to cause the processing circuit to obtain, by the processing circuit, first scan results of a security threat scan of a first device using a first threat assessment application. The program instructions also cause the processing circuit to obtain, by the processing circuit, second scan results of a security threat scan of the first device using a second threat assessment application. Moreover, the program instructions cause the processing circuit to combine, by the processing circuit, the first scan results and the second scan results to produce a single security profile for the first device on a per session basis. In addition, the program instructions cause the processing circuit to manage, by the processing circuit, actions of the first device in a session with a peer device based on the single security profile for the first device, and share, by the processing circuit, the single security profile for the first device with other peer devices in a network on a per application and on the per session basis.

The embodiments described above may be implemented in any computing system environment known in the art, such as a networking environment, which may include a processor and a computer readable storage medium configured to store data and logic, the logic being implemented with and/or executable by the processor to cause the processor to perform one or more functions.

### BRIEF DESCRIPTION OF THE DRAWINGS

The following descriptions of the drawings are not meant to be limiting on what is taught by the drawings in any manner. For a fuller understanding of the content of each drawing, the following brief descriptions are provided, which when read in conjunction with the detailed description, describe the full breadth of the various embodiments of the present invention.

FIG. 1 shows a network architecture, according to one embodiment.

FIG. 2 shows a hardware environment that may be associated with the network architecture of FIG. 1, according to one embodiment.

FIG. 3 shows a logical representation of an application instance operating on a computing system, in accordance with one embodiment.

FIG. 4 shows an application and data protection library (ADPL) control model implemented in a data center, according to one embodiment

FIG. 5 shows several application instances operating in a virtual environment, according to one embodiment.

FIG. 6 shows a flowchart of a method, according to one embodiment.

### DETAILED DESCRIPTION

The descriptions presented herein are intended to enable any person skilled in the art to make and use the present invention and are provided in the context and requirements of particular applications of the present invention.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified.

Moreover, the term “about” when used herein to modify a value indicates a range that includes the value and less and greater than the value within a reasonable range. In the absence of any other indication, this reasonable range is plus and minus 10% of the value. For example, “about to milliseconds” indicates 10 ms±1 ms, such that the range includes all values in a range including 9 ms up to and including 11 ms.

Also, the term “comprise” indicates an inclusive list of those elements specifically described without exclusion of any other elements. For example, “a list comprises red and green” indicates that the list includes, but is not limited to, red and green. Therefore, the list may also include other colors not specifically described.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown and described herein, but is to be accorded the widest scope consistent with the principles and features disclosed herein.

In particular, various embodiments of the invention discussed herein may be implemented using a network, such as the Internet, to communicate among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN), or other communication media. In addition, various combinations of wired (e.g., Ethernet), wireless (e.g., radio frequency) and optical communication links (e.g., fiber optic) may be utilized.

The term application as used herein refers to any type of software and/or hardware-based application, such as enterprise data center applications, Internet-of-Things (IOT) applications, Industrial control applications, military applications, etc.

Enterprise data center applications may include any of the following application types: financial applications, equity trading applications, healthcare applications, financial transaction applications, etc.

IOT applications may include any of the following application types: mobile communication applications, home automation/control applications, industrial automation/control applications, security and monitoring applications, etc.

Industrial control applications may include any of the following application types: nuclear power plant control, thermal power plant control, hydro-electric power plant control, wind farm control, electricity grid and distribution control, water treatment control, land-based traffic control, air traffic control, etc.

Military applications may include any of the following application types: military installation control, first alert system control, autoguided weapon system control, military weaponized equipment control including manned vehicles, weaponized and/or surveillance-oriented unmanned vehicle control (drones) such as unmanned aerial vehicles (UAVs), unmanned aircraft systems (UASs), unmanned underwater vehicles (UUVs), unmanned ground vehicles (UGVs), etc.

A program environment in which one embodiment may be executed illustratively incorporates one or more general-purpose computers and/or special-purpose devices, such as switches, routers, switch controllers, etc. Details of such devices (e.g., processor, memory, data storage, input devices, and output devices) are well known and are omitted for the sake of clarity.

It should also be understood that the techniques of the present invention may be implemented using a variety of technologies. For example, the methods described herein may be implemented in software running on a computer system, implemented in hardware utilizing one or more hardware processors and logic (hardware logic and/or software logic) implemented with and/or executable by the hardware processor. The logic is configured to cause the processor to perform operations of a method, and may take any form known to those of skill in the art, such as application specific integrated circuits (ASICs), programmable logic devices such as Field Programmable Gate Arrays (FPGAs), and/or various combinations thereof.

In one illustrative approach, methods described herein may be implemented by a series of computer-executable instructions stored to a computer readable storage medium, such as a physical (e.g., non-transitory) data storage medium. In addition, although specific embodiments may employ object-oriented software programming concepts, the present invention is not so limited and is adaptable to employ other forms of directing the operation of a processor.

The present invention may also be provided in the form of a computer program product comprising a computer readable storage medium having program instructions thereon or a computer readable signal medium having program instructions therein, which may be executed by a computing device (e.g., a processor) and/or a system. A computer readable storage medium may include any medium capable of storing program instructions thereon for use by a computing device or system, including optical media such as read only and writeable CDs and DVDs, magnetic memory or media (e.g., hard disk drive, magnetic tape, etc.), semiconductor memory (e.g., FLASH memory, non-volatile random access memory (NVRAM), and other non-volatile storage media known in the art), firmware encoded in a microprocessor, etc.

A computer readable signal medium is one that does not fit within the aforementioned computer readable storage medium definitions. For example, illustrative computer readable signal media communicate or otherwise transfer transitory signals within a system, between systems, etc., e.g., via a physical or virtual network having a plurality of connections.

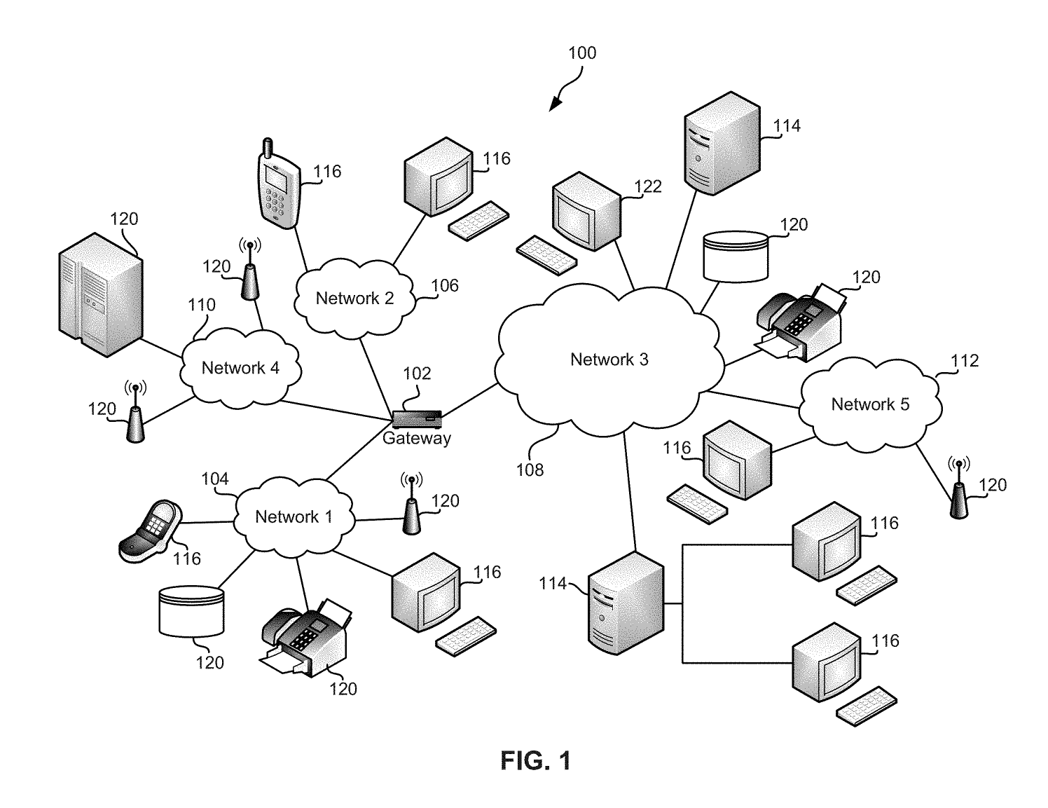

FIG. 1 illustrates an architecture 100, in accordance with one embodiment. As an option, the present architecture 100 may be implemented in conjunction with features from any other embodiment listed herein, such as those described with reference to the other figures. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks are provided including a first remote network 104 and a second remote network 106. A gateway 102 may be coupled between the remote networks 104, 106 and a proximate network 108. In the context of the present network architecture 100, the networks 104, 106 may each take any form including, but not limited to, a LAN, a WAN such as the Internet, a storage area network (SAN), a public switched telephone network (PSTN), an internal telephone network, etc. Additional networks 110, 112 may also be connected via the gateway 102 or some other connection device known in the art. These networks may be of a different type than the networks 104, 106. For example, network 110 may be a network devoted to the IOT, and may provide infrastructure and protocols for communication between all devices in the IOT, and between any devices in the IOT and the networks 104, 106. In another example, network 112 may be a network devoted to Industrial control, and may provide infrastructure and protocols for communication within and/or between facilities anywhere in the world, including automated devices, manufacturing lines, assembly lines, processing control software, etc.

In use, the gateway 102 serves as an entrance point from the remote networks 104, 106 to the proximate network 108. As such, the gateway 102 may function as a router, which is capable of directing a given packet of data that arrives at the gateway 102, and a switch, which furnishes the actual path in and out of the gateway 102 for a given packet.

Further included in the network architecture 100 is at least one data server 114 coupled to the proximate network 108, and which is accessible from the remote networks 104, 106 via the gateway 102. It should be noted that the data server(s) 114 may include any type of computing device/groupware. Coupled to each data server 114 is a plurality of user devices 116. User devices 116 may include any device known by those of skill in the art, such as a desktop computer, a laptop computer, a hand-held computer, a smartphone, a terminal, a port, a printer, some type or form of logic, etc. It should be noted that a user device 122 may also be directly coupled to any of the networks, in one embodiment.

A peripheral 120 or series of peripherals 120, e.g., facsimile machines, printers, networked storage units, hard disk drives, wireless routers, etc., may be coupled to one or more of the networks 104, 106, 108, 110, 112. It should be noted that databases, servers, mainframes, and/or additional components may be utilized with and/or integrated into any type of network element coupled to the networks 104, 106, 108, 110, 112. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of virtualization software, such as VMWARE ESX, MICROSOFT HYPER-V, SIMICS, etc., in some embodiments.

In more approaches, one or more of the networks 104, 1006, 108, 110, 112 may represent a cluster of systems commonly referred to as a “cloud.” In cloud computing, shared resources, such as processing power, peripherals, software, data processing, servers, storage, etc., are provided to any system that has access to the cloud and permission to access the specific resource, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used as would be understood by those of skill in the art.

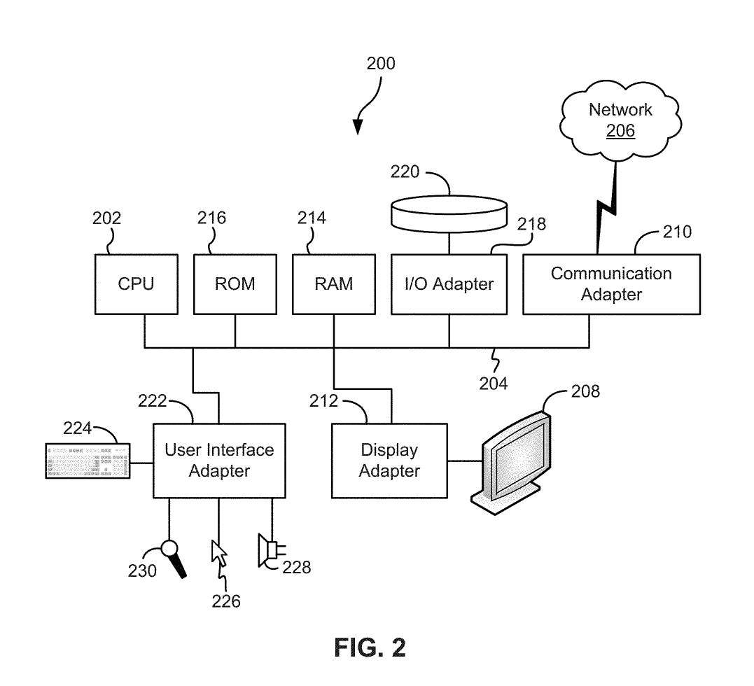

FIG. 2 shows a representative hardware environment associated with a user device 116 and/or a server 114 of FIG. 1, in accordance with one embodiment. FIG. 2 illustrates a typical hardware configuration of a workstation 200 having a central processing unit 202, such as a microprocessor, and a number of other units interconnected via a system bus 204.

The workstation 200 shown in FIG. 2 includes a Random Access Memory (RAM) 214, Read Only Memory (ROM) 216, an I/O adapter 218 configured to connect peripheral devices, such as disk storage units 220 to the bus 204, a user interface adapter 222 configured to connect a keyboard 224, a mouse 226, a speaker 228, a microphone 230, and/or other user interface devices such as a touch screen, a digital camera, etc., (not shown) to the bus 204, communication adapter 210 configured to connect the workstation 200 to a communication network 206 (e.g., a data processing network) and a display adapter 212 configured to connect the bus 204 to a display device 208.

The workstation 200 may have resident thereon an operating system, such as the MICROSOFT WINDOWS Operating System (OS), a MAC OS, a UNIX OS, etc. It will be appreciated that a preferred embodiment may also be implemented on platforms and operating systems other than those specifically mentioned herein. A preferred embodiment may be written using JAVA, XML, C, and/or C++ language, SCALA, COBOL, FORTRAN, or other programming languages, along with an object oriented programming methodology or scripting language such as PERL, PYTHON, Tcl/Tk, or other scripting languages. Object oriented programming (OOP), which has become increasingly used to develop complex applications, may also be used.

Moreover, one or more hardware processors may be implemented in a processing circuit in the workstation 200. The processing circuit includes the one or more hardware processors, along with any connections or links therebetween necessary to interconnect the one or more processors in the processing circuit. In addition, the processing circuit may be implemented with logic and/or may be configured to execute logic, with the logic being configured to cause the processing circuit to perform functionality specified by the logic.

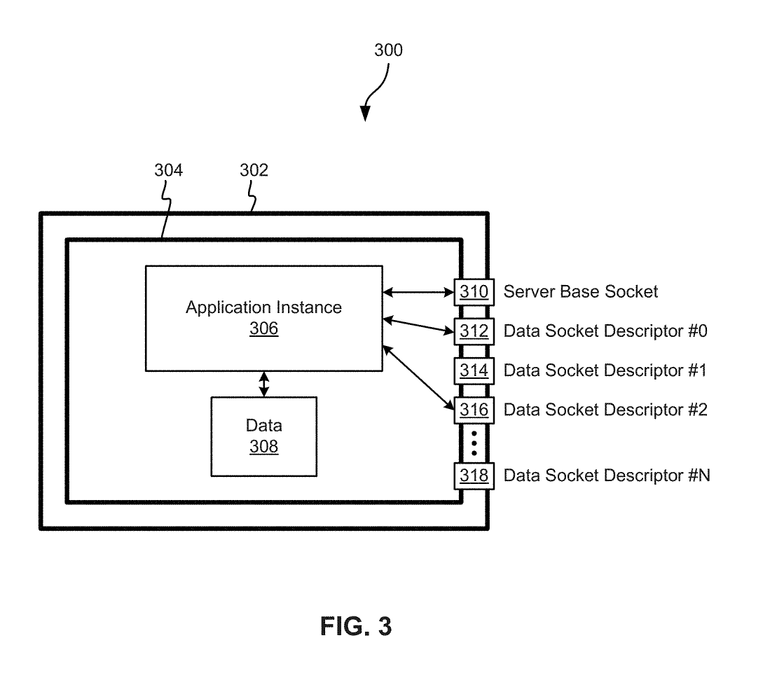

Now referring to FIG. 3, a logical representation of an application instance 306 operating on a computing system 300 is shown according to one embodiment. Although only one application instance 306 and one set of data 308 is shown in FIG. 3, as would be understood by one of skill in the art, any number of application instances and groups of data may be hosted on a computing system 300, limited only by the processing power and/or other resources available to the computing system 300.

As shown in FIG. 3, an application protection layer (APL) 302 and a data protection layer (DPL) 304 are represented within the computing system 300, according to one embodiment. The application instance 306 has access to data 308 within the computing system 300. Also, the application instance 306, through any number of standard and/or custom application programming interfaces (APIs), may utilize any of a plurality of data socket descriptors (e.g., data socket descriptor #0 312, data socket descriptor #1 314, data socket descriptor #2 316, . . . , data socket descriptor #N 318) with which to communicate (send and/or receive) information outside of the application instance 306 or computing system 300. One or more server base sockets 310 is provided in the application instance 306 of computing system 300 and is used for control of the peer application instances on the computing system 300, outside the system, or outside the application instance 306 itself, as would be understood by one of skill in the art.

Many, but not all, scaled-out enterprise applications, such as those used in the fields of finance, banking, stock market investing, monetary analytics, web traffic analytics, data analytics, web searching, etc., have built-in capabilities that allow an individual instance of a scaled-out distributed application to protect itself from malicious software and data breaches. Many of the operating systems on which these scaled-out enterprise applications operate also have capabilities to protect themselves from external denial of service attacks, application vulnerability attacks, data stealing malware attacks, etc. The individual applications and operating systems perform these security capabilities using multiple built-in techniques, some of which are discussed below. For example, most database systems have the following capabilities:
1. Policy-based data redaction
2. Programmable cache flushing
3. Memory protection or locking
4. Database locking (including locking one or more individual rows and/or columns of a database)
5. Secure Socket Layer (SSL) capabilities to encrypt transport payload(s)
6. Partial application-payload encryption
7. Distributed denial of service (DDoS) checks
8. Protocol anomaly checks
9. Other standard and proprietary protections not listed above

Although, these features partially protect an individual application instance or database, they fail to protect the complete distributed application system as a scaled out and/or distributed application. Various parts or portions of the application have differing capabilities to protect themselves. When the applications in a data center or enterprise are allowed to exchange their own capabilities of protection with each other using secure exchange information, the complete application ecosystem would be allowed to take advantage of the individual application's capabilities and enable a correct or most appropriate response decision about the systemic and session level security issues facing one or more distributed application instances.

In order to provide application and data protection to application instances of distributed, scaled-out applications which have instances operating on a plurality of computing systems, at least two operations may be performed, and are described below according to one embodiment.

In a first operation, application instances, such as application instance 306, are identified based upon data socket descriptor attributes that an application instance uses to communicate between other application instances and/or group(s) of application instances on/or outside of the computing system 300. For example, in response to application instance 306 utilizing data socket descriptor #0 312 consistently to communicate with another system, an association may be established between data socket descriptor #0 312 and the application instance 306. By consistently, what is meant is that application instance 306 utilizes data socket descriptor #0 312 to communicate with another system more than a predetermined number of times within a given period of time, according to one embodiment. In another embodiment, consistently utilizing a data socket descriptor means that only a specific data socket descriptor is used in exclusion of all others over a given period of time.

In a second operation, a group is formed which includes any application instance which has all of the same socket descriptor attributes (or at least a predetermined amount of the same socket descriptor attributes, or the same of a certain group of socket descriptor attributes), e.g., data exchange sockets of the same application base socket, transport protocol, server port, various multi-tenancy characteristics, storage characteristics, payload sizes, container attributes, and/or multiple time contexts are grouped together.

Any socket descriptor attributes may be considered when determining whether an application instance shares data socket descriptor attributes with another application instance, such as OS and container attributes which include server port, transport protocol, network address translation (NAT) IP address range, maximum transmission unit (MTU), application payload sizes, user programmable attributes such as multi-tenancy labels, etc.

Using the above two operations, two layers of protection (application protection and data protection) are enacted together to protect the application (not shown) from which the application instance 306 is provided and any group of application instances related to the application that provides the application instance 306.

The APL 302 works with data socket APIs and data socket libraries to provide protection to application instances and to the data that is used by the application instances. While doing so, the APL 302 does not interfere with the application architecture and its normal behavior. Though these new APIs, each application instance receives extra capabilities to ensure that all flows entering and exiting the application instance are trusted flows. Moreover, the APL 302 receives additional infrastructural help by being informed about the security status of virtual and/or physical servers on which the application instance is running, along with the security status of other application instances and their virtual and/or physical servers. Based on the comprehensive status of the servers and network in the data center, the APIs provide feedback and suggest use of data protection mechanisms to protect data in memory and cache.

FIG. 3 shows the Application and Data Protection Layer (ADPL) libraries which keep track of the server base socket 310 and various data socket descriptors 312, 314, 316, . . . , 318 opened by an application instance 306 for communication of data with one or more peer applications outside of the computing system 300. The data socket descriptors 312, 314, 316, . . . , 318 are used for the exchange of data with another system outside of the computing system 300.

The data socket descriptors 312, 314, 316, . . . , 318 are numbers that represent attributes and/or characteristics of different data exchanges between the application instance and one or more receiver hosts. Each data socket descriptors 312, 314, 316, . . . , 318 may have a size ranging from 12 to 48 bits, such as 32 bits in one embodiment.

Each of the APL 302 and the DPL 304 utilize individual sets of APIs that are configured to piggyback on existing APIs, but add specialized functionality to any action performed using the existing APIs.

These new socket APIs and data protection APIs, and the type of application payload sent and received, do not disturb the intermediate security appliances such as firewall, Intrusion Prevention and Intrusion Detection, etc.

The application instance 306 utilizes the one or more server base socket(s) 310 with standard and/or private well-known port number(s) as a control socket, but opens a new data socket descriptor and allocates a different port number to the new data socket descriptor in order to handle actual functionality and data transfer between the computing system 300 and any other external or peer system.

The server base socket 310 has the following attributes and/or characteristics:
10. A server and/or a source internet protocol (IP) interface.
11. A standard and/or known server port number, e.g., transmission control protocol (TCP) port, user datagram protocol (UDP) port, etc.
12. A maximum number of allowable waiting connections.
13. A maximum (and possibly minimum) application packet buffer size usable for transmitting and receiving data.
14. Other socket options provided by the operating system, the user, or an external input.

The above described attributes and/or characteristics may also be attributed to the plurality of allocated data socket descriptors 312, 314, 316, . . . , 318. When a connection is established between the computing system 300 and another system via the application instance 306, a data socket descriptor is allocated. The allocated data socket descriptor has the following attributes and/or characteristics:
1. A server and/or a source IP interface.
2. A standard and/or known server port number, e.g., TCP port, UDP port, etc.
3. A maximum number of allowable waiting connections.
4. Application packet buffer size for transmit and receive.
5. A port number of the transport of the allocated data socket descriptor (in the computing system 300).
6. An IP address of the peer data socket descriptor (in an external system) of the allocated data socket descriptor (usually, but not always, in TCP sockets).
7. A port number of the transport of the peer data socket descriptor of the allocated data socket descriptor in all cases of controlled port allocations by the application instance 306.
8. A maximum (and possibly minimum) application packet buffer size usable for transmitting data to and receiving data from (transmissions with) the peer data socket descriptor.

Apart from the above described characteristics and/or attributes, additional characteristics that may be attributable to an allocated data socket descriptor include:
9. A first identifier (ID1): a globally unique identification number given for an entity (such as an enterprise, company, university, city subdivision, etc.) that utilizes the ADPL mechanism in the application instances or programmed for proprietary purposes
10. A second ID (ID2): a unique identification number within the entity (not necessarily globally unique). Each ID2 represents a subdivision within the entity, such as an individual business unit within an enterprise, a water district within a city, etc., or programmed for proprietary purposes.
11. Secure base signature: a base signature or scrambled alphanumeric or numerical code used in the generation of signatures per data socket descriptor.
12. Secure runtime signature: a scrambled alphanumeric or numerical code used as a signature on a per data socket descriptor basis.
13. Application name: a name given to the application instance operating on the computing system.
14. Application ID: an identification number provided to the application instance operating on the computing system.
15. Process ID: an identification number provided to a particular process which is accountable for the data.
16. Server port: the particular port on the server on which data is received or sent.
17. Transport protocol: the particular transport protocol used to send data.
18. Base Crypto Version: the version of the cryptographic process used to encrypt data.
19. Co-Lo Need: Co-locationing criterions where applications or application instances may reside together in the same server, server pool, rack, pod, or data center.
20. Architecture Tier: a tier within the system architecture on which the (web, application, database, etc.) operates.
21. Storage Attachments: an attribute that describes how the storage is attached to the computing system (e.g., direct, network, distributed, etc.)
22. Proprietary Multi-Tenant Label: a label within the ADPL tag which designates some information selectable by the user.

These unique attributes when combined together in one of many different variations, are able to identify a data socket descriptor, and locks that data socket descriptor to one particular instance of a scaled-out application group.

ADPL library functions may be used by the application instance 306 to send and receive data using operating system data sockets 312, 314, 316, . . . , 318. ADPL library functions may add all security mechanisms around the socket APIs. Modules in the ADPL architecture include: a security policies database which includes secure application policies specific to E-W policies and N-S policies, and secure data policies. Additional modules include a socket descriptor database, packet processing functions, a management process, and a configuration and logging mechanism.

The ADPL uses micro-security policies with which to secure the application instance 306 and the data 308. Every ingress packet on a selected data socket descriptor (e.g., data socket descriptor #2 316) is verified against the micro-security policies. Security policies are defined as operands, actions/operations, and sub-actions.

There are two types of application security policies applied by the APL 302: E-W Policies and N-S Policies. E-W Policies dictate and limit data socket use in communications with other data sockets and/or servers within the data center. N-S Policies dictate behavior of data sockets that communicate between servers within the data center and hosts and/or servers outside the data center.

Data security policies refer to complex data-type centric policies. These policies are triggered by the security profile of the data socket based on the data socket descriptor on which data is exchanged. Based on the security profile, the data exchange is allowed, restricted, or limited. The security profile is derived from the packet options which are available via data socket options, in one embodiment.

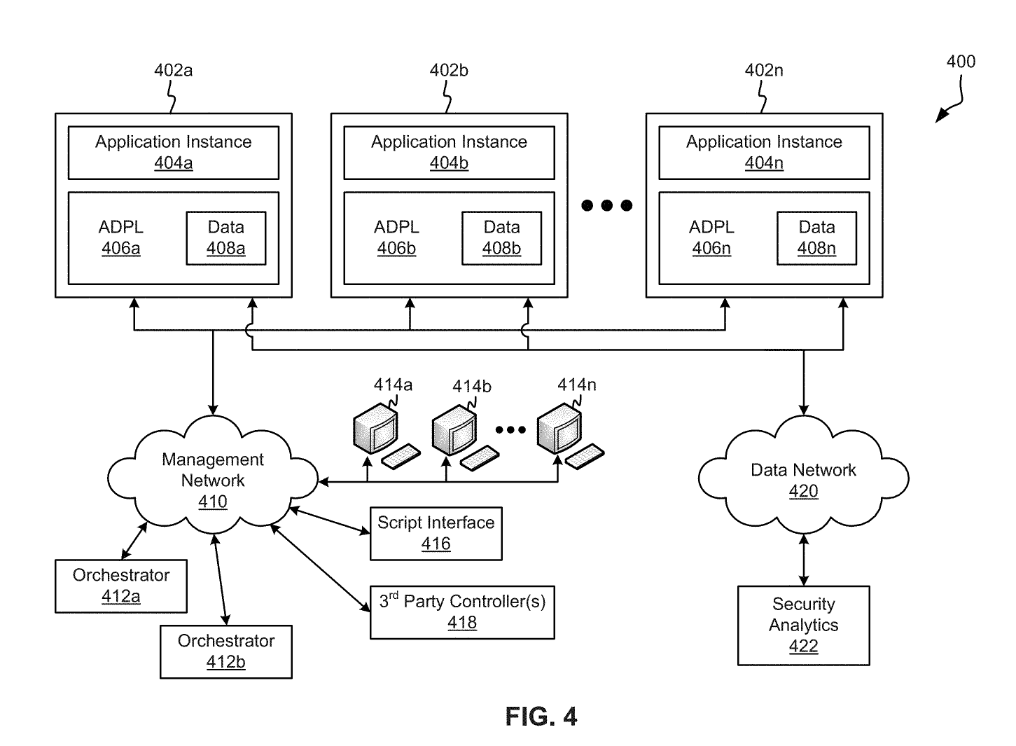

FIG. 4 shows the ADPL control model implemented in a data center 400, according to one embodiment. As shown, one or more policy orchestrators 412a, 412b is associated with the management network 4100. More than one policy orchestrator may be utilized in high availability (HA) mode. Each policy orchestrator 412a, 412b may include segment management, policies management, configuration management, application tracking, a security trending controller, and software defined control.

From the management network 410, APIs, such as representational state transfer (REST) APIs (among others known in the art), may be distributed to the plurality of management consoles 414a, 414b, . . . , 414n, the scripted interface 416, and/or to one or more third party controllers 418. Each of the plurality of management consoles 414a, 414b, . . . , 414n may include a graphical interface, REST API-based programmability, trending, analysis, auditing, and third party controller integration.

One or more virtual platforms 402a, 402b, . . . , 402n host one or more ADPL-shielded application instances 404a, 404b, . . . , 404n along with data 408a, 408b, . . . , 408n utilized by each application instance 404a, 404b, . . . , 404n which are protected by ADPLs 406a, 406b, . . . , 406n.

The primary policy orchestrator 412a communicates to the one or more ADPL-shielded application instances 404a, 404b, . . . , 404n through the management network 410. Each of the ADPLs 406a, 406b, . . . , 406n operating for each individual application instance 404a, 404b, . . . , 404n may include application protection and policy enforcement, data protection and policy enforcement, and collection of statistics of normal and malicious behavior.

The data network 420 is associated with a security analytics module 422 which may include a security analytics engine and a collection of security analysis tools. In more approaches, the security analytics module 422 may include FireEye Sandbox, and/or other third party security analysis tools, from third parties such as IBM, CISCO, SYMANTEC, MCAFEE, etc. Moreover, the security analytics module 422 may provide feedback to the one or more policy orchestrators 412a, 412b.

One or more of the application instances 404a, 404b, . . . , 404n may be grouped together in pico-segments or groups that each include related socket descriptors and data socket descriptors of application instances that share characteristics based on data socket descriptors, among other characteristics. The policy orchestrator 412a, 412b interacts with the various pico-segments of application instances in which ADPL-shielded application instances 404a, 404b, . . . , 404n are grouped together as a whole, rather than with each individual application instance individually.

In one embodiment, socket APIs and/or libraries are used to provide protection to applications and application data. While providing such protection, the mechanism does not interfere with the application architecture and normal behavior of the application and instances thereof. Through these new socket APIs, an application is awarded extra capabilities that allow the application to obtain additional infrastructural help and knowledge.

This help and knowledge includes the security status of virtual and/or physical server(s) on which the application is operating, the security status of other peer applications and their virtual and/or physical servers, details of types of attacks that have occurred on the peer application instances, a number of times each of the peer application instances have suffered breach attempts, etc. Based on the comprehensive security status of many or all servers in the data center, and each network thereof, the APIs provide feedback per socket descriptor to the applications and also provide suggests on use of data protection mechanisms to protect clear data being exchanged with peer applications and/or clients.

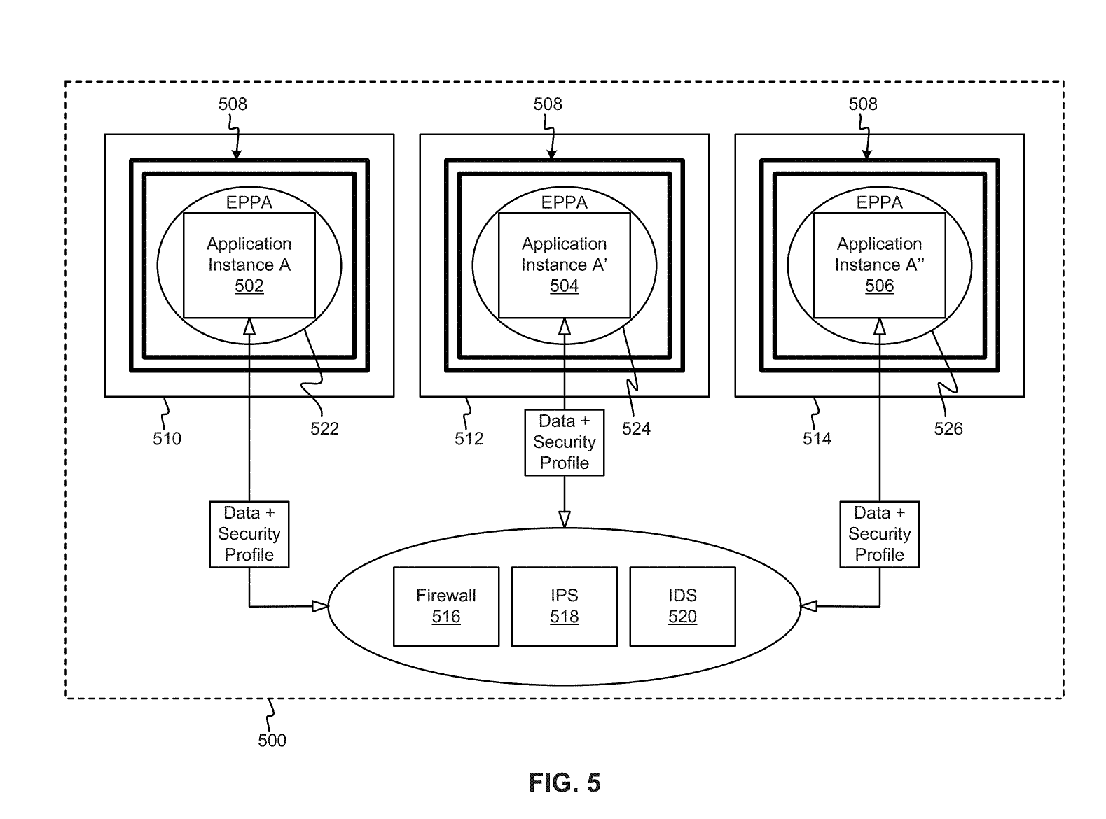

Now referring to FIG. 5, three instances of an application, Application Instance A 502, Application Instance A′ 504, and Application Instance A″ 506 are shown running in a virtual environment 500 on one or more virtual platforms, such as hypervisors. Many more than three instances of an application may be running in the virtual environment 500 at any one time as would be understood by one of skill in the art, on the order of thousands or millions in some cases. An ADPL 508 provided by secure APIs called by the hosts, Host A 510, Host B 512, and Host C 514, enables application protection via policies and also provides data protection by sharing a security status and security profile with any peer application instances operating on other hosts (Application Instance A 502 is a peer to Application Instance A′ 504, Application Instance A′ 504 is a peer to Application Instance A″ 506, Application Instance A″ 506 is a peer to Application Instance A 502, and so forth). Using the security profile of the peer application instance, the protected application instance is provided the capability to apply various data security mechanisms to protect itself from malicious code and data breach attacks.

Each instance of the application (e.g., Application Instance A 502, Application Instance A′ 504, Application Instance A″ 506, etc.) may run on the same physical machine or on different physical or virtual machines in the data center. However, all the application instances communicate with each other to share data and other information to satisfy queries.

New socket APIs and data protection APIs that are utilized to provide the protection do not disturb any intermediate security appliances used in the network and/or on the servers or hosts, such as a firewall 516, an Intrusion Prevention System (IPS) 518, an Intrusion Detection System (IDS) 520, etc.

The ADPL 508 around the socket descriptors for database applications creates a mapping of security profile policies with the application per data socket descriptor to perform various security feature functionality, such as dynamic cache flush, dynamic data redaction, locking of in-memory database(s), etc. These security features are configured to be applied on a per application instance per session basis. As a result, a database server is allowed to enact a dynamic security feature depending upon the security profile of that particular session at that time, thereby avoiding cache scraping, data breaches, or other unwanted intrusion by malware or nefarious applications.

An EPPA 522 on Host A 510 creates security results which indicate the presence of one or more risks to Host A 510. The ADPL 508 interprets the security results provided by the EPPA 522 operating on Host A 510, and shares these interpreted security results with Application Instance A 502.

A similar mechanism is provided on with EPPA 524 on Host B 512, and EPPA 526 on Host C 514. The ADPL 508 also interprets the security results provided by the EPPA 524 operating on Host B 512, and shares these interpreted security results with Application Instance A′ 504, and interprets the security results provided by the EPPA 526 operating on Host C 514, and shares these interpreted security results with Application Instance A″ 506.

Moreover, according to one embodiment, the ADPL 508 is configured to share the interpreted security results of EPPA 522 operating on Host A 510 with Host B 512 and Host C 514, along with Application Instance A′ 504, Application Instance A″ 506, and any other applications operating on Host A 510, Host B 512, and Host C 514.

In another embodiment, the ADPL 508 is configured to share the interpreted security results of EPPA 524 operating on Host B 512 with Host A 510 and Host C 514, along with Application Instance A 502, Application Instance A″ 506, and any other applications operating on Host A 510, Host B 512, and Host C 514.

According to another embodiment, the ADPL 508 is configured to share the interpreted security results of EPPA 526 operating on Host C 514 with Host A 510 and Host B 512, along with Application Instance A 502, Application Instance A′ 504, and any other applications operating on Host A 510, Host B 512, and Host C 514.

In one embodiment, the interpreted security results may include a security profile range that is indicated by the ADPL 508 to the other applications and/or hosts in the data center. The security profile range may utilize a color scheme, in one embodiment. For example, the security profile range may take on the colors of red, yellow, green, and normal.

According to one embodiment, the security profile range may account for the presence and/or detection of one or more of the following risk types: malware presence, virus presence, rogue security software, Trojan horse, malicious spyware, computer worm, botnet, spam incidences, phishing incidence, rootkit (the tool kit used to obtain administrative privileges), outdated version of EPPA, etc.

The security profile range may be calculated as a sum of percentages of individual risk/security parameters on a per-server per-socket descriptor basis. Some risk/security parameters may be provided by, but are not limited to being obtained from, a library mechanism executed in the ADPL 508 that evaluates various attempted and/or foiled attacks on the application instance to provide risk assessment, one of the EPPAs 522, 524, 526, e.g., products from SYMANTEC, MCAFEE, KASPERSKY, etc., where the EPPA may derive the risk assessment using a signature based mechanism, behavior analysis based mechanism, neural network based mechanism, etc., along with other sources included in the application instance, the host, or provided by the user.

In one embodiment, the total sum of percentages of risks from individual sources may be categorized and ranged in various value ranges. The highest range may be indicated by the color RED, a second highest range may be indicated by the color YELLOW, a third highest range may be indicated by the color GREEN, and a range that indicates no risks may be indicated by no color.

In one embodiment, multiple security threat scans on the same server or end host may be performed using different threat assessment applications in order to obtain a plurality of scan results. For example, an EPPA and the ADPL operating on a first device may both provide security threat scans of the first device. These security threat scan results may be combined to form a single security profile for the first device on a per session basis. The “on a per session basis” indicates that connections with other peer devices operating another instance of an application that is operating on the first device are also evaluated to determine vulnerabilities stemming from the use of the application on the first device. Both the EPPA and the ADPL may be used to assess such threats.

The effect that each of the security threat scan results have on the single security profile for the first device on the per session basis may be based, in one embodiment, on a percentage severity considered for each source of security threat scan results. For example, security threat scan results from one or more EPPAs may be weighted to provide 70% of the single security profile for the first device, while security threat scan results from the ADPL operating on the first device may provide 30% of the single security profile for the first device. These percentages are programmable, and may be adjusted based on one or more characteristics of the application operating on the first device.

The characteristics of the application operating on the first device may include, but are not limited to, how many peer devices the application communicates with, a security profile of any peer devices, types of behaviors that the application typically engages in (such as downloading executables, sharing sensitive information with peers, outputting security rights information, etc.), etc.

As a guideline, the percentage weight assigned to the security scan results of the EPPA(s) may be at least twice the percentage weight assigned to the ADPL operating on the first device.

In another embodiment, which may be used in conjunction with weighting the percentage severity considered for each source of security threat scan results described above, or alone, individual security threat types may be weighted to produce the security scan results for a particular security threat assessment application. This may apply to the ADPL, the EPPA, or any other security threat assessment application, technique, device, or module operating in the network in which the first device is located.

With reference to Table 1, in this embodiment, a programmable percentage probability value (XN) is assigned for each type of threat detectable by the security threat assessment application, such as the EPPA. This value may then be multiplied by a second programmable factor (pN/100), to determine a percentage severity (Xi*pi/100) considered for each threat type. All of the percentage severities for all detected threat types are summed to obtain the total percentage severity (Σᵢ^{N} Xi*pi/100) considered for the first device on a per session basis, taking into consideration threat type. The “others” threat type may include undeterminable threat types, or recognizable threat types may be lumped together into one category when their severity is not substantial enough to justify a separate threat type analysis, in alternate embodiments.

TABLE 1

| | Percentage | Percentage Severity |
|---|---|---|
| Risk Profile Type | Probability Value | Considered |
| Malware | X0 | X0 * p0/100 |
| Virus | X1 | X1 * p1/100 |
| Rogue Security Software | X2 | X2 * p2/100 |
| Trojan Horse | X3 | X3 * p3/100 |
| Malicious Spyware | X4 | X4 * p4/100 |
| Computer Worm | X5 | X5 * p5/100 |
| Botnet | X6 | X6 * p6/100 |
| Spam | X7 | X7 * p7/100 |
| Phishing | X8 | X8 * p8/100 |
| Rootkit | X9 | X9 * p9/100 |
| Outdated Version of EPPA | X10 | X10 * p10/100 |
| Others | X11 | X11 * p11/100 |
| TOTAL | | ΣXi * pi/100 |

This calculation relies on a determination as to which types of detectable threats are detected according to the scan results utilized. When a threat type is not detected, then its percentage probability value is not included in the total percentage severity.

In yet another embodiment, which may be used in conjunction with either of the two weighting schemes described above individually or collectively, or alone, individual statistic components for security profiling may be summed to produce the security scan results for a particular security threat assessment application. This may apply to the ADPL, the EPPA, or any other security threat assessment application, technique, device, or module operating in the network in which the first device is located.

With reference to Table 2, in this embodiment, a programmable percentage severity association (RN) is assigned for each risk profile type detectable by the security threat assessment application, such as the ADPL All of the percentage severities for all detected risk profile types are summed to obtain the total percentage severity (Σᵢ^{N} Ri) considered for the first device on a per session basis, taking into consideration risk profile type.

TABLE 2

| Risk Profile Type | Percentage Severity Association |
|---|---|
| Total number of sessions rejected | R0 |
| due to policies | |
| Total number of sessions rejected | R1 |
| due to first ID mismatch | |
| Total number of sessions rejected | R2 |
| due to second ID mismatch | |
| Total number of application | R3 |
| session payloads rejected due to | |
| policies | |
| Total number of application | R4 |
| session payloads rejected due to | |
| first ID mismatch | |
| Total number of application | R5 |
| session payloads rejected due to | |
| second ID mismatch | |
| Total number of application | R6 |
| session payloads rejected due to | |
| secure signature mismatch | |
| Total number of application | R7 |
| session payloads bytes rejected | |
| due to secure signature | |
| TOTAL | ΣRi |

This calculation relies on a determination as to which types of risk profiles are detected according to the scan results utilized. When a risk profile type is not detected, then its percentage severity association is not included in the total percentage severity.

When the three embodiments described above are combined, in one embodiment, the total security profile may be determined as shown in Table 3.

TABLE 3

| Risk Profile Source | Value | % per 70/30 split |
|---|---|---|
| EPPA | ΣXi * pi/100 | 70% |
| ADPL | ΣRi | 30% |
| TOTAL | | (ΣXi * pi/100) * 0.7 + (ΣRi) * 0.3 |

In this embodiment, a default value of contribution by an individual source is 70% and 30% for the EPPA and the ADPL, respectively. New sources may be added dynamically on the fly in response to detection of additional risk assessment applications, with the percentage split being modified according to how heavily each risk assessment application is desired to be weighted. The percentage contribution values or weightage may be changed for different outcomes, depending on application requirements, weaknesses, perceived strengths, etc. The local result for a particular application on a per session basis may then be assigned a color according to a range of its individual security profile, as described previously with the color schemes of RED, YELLOW, GREEN, or NORMAL range values, which may then be shared per session with any peer devices operating an instance of the application.

With the availability of mapping between the security profiles of each socket descriptor and an encryption policy, a new dynamic security profiling mechanism is created. With this mechanism, a security profile for the individual session may be provided to the application by the underlying ADPL by use of various standard and proprietary socket APIs, e.g., getsockopt( ), avcd_getsockopt( ), etc. Based on application needs, the application may call any of these APIs to understand the security profile of the session and any suggested actions to make the session more secure. Accordingly, the ADPL may apply the actions to that particular session, at the same time, applying different actions to other sessions.

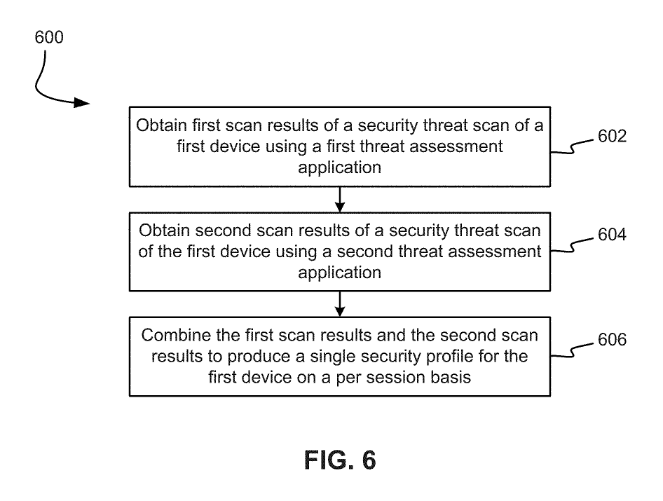

Now referring to FIG. 6, a flowchart of a method 600 is shown according to one embodiment. The method 600 may be performed in accordance with the present invention in any of the environments depicted in FIGS. 1-5, among others, in various embodiments. Of course, more or less operations than those specifically described in FIG. 6 may be included in method 600, as would be apparent to one of skill in the art upon reading the present descriptions.

Each of the steps of the method 600 may be performed by any suitable component of the operating environment. For example, in various embodiments, the method 600 may be partially or entirely performed by a server, host, computing system, processor, switch, or some other device having one or more processing units therein. The processing unit, e.g., processing circuit(s), chip(s), and/or module(s) implemented in hardware and/or software, and preferably having at least one hardware component, may be utilized in any device to perform one or more steps of the method 600. Illustrative processing units include, but are not limited to, a central processing unit (CPU), an ASIC, a FPGA, etc., combinations thereof, or any other suitable computing device known in the art.

As shown in FIG. 6, method 600 may initiate with operation 602, where first scan results of a security threat scan of a first device are obtained using a first threat assessment application. The first threat assessment application may be executed by the processing circuit of the first device, such as a statistic risk profiler of an ADPL operating on the first device, in one embodiment. In another embodiment, the first threat assessment application may be executed on a remote device from the first device, such as an EPPA, that is configured to assess risks presented by the first device to itself and other peer devices in the network.

In operation 604, second scan results of a security threat scan of the first device are obtained using a second threat assessment application. The second threat assessment application may be executed by the processing circuit of the first device, such as a statistic risk profiler of the ADPL operating on the first device, in one embodiment. In another embodiment, the second threat assessment application may be executed on a remote device from the first device, such as an EPPA, that is configured to assess risks presented by the second device to itself and other peer devices in the network.

In operation 606, the first scan results and the second scan results are combined to produce a single security profile for the first device on a per session basis. This single security profile may be provided to any peer device attempting communications with the first device, to a controller of the network (such as a software defined network (SDN) controller, OpenFlow controller, etc.), to end devices and/or hosts in or outside of the network, etc.

In one embodiment, method 600 may include allocating a first percentage weight value to the first scan results and allocating a second percentage weight value to the second scan results. The sum of the first percentage weight and the second percentage weight totals 100%, such that the totality of the single security profile is composed of the two individual first and second scan results.

In a further embodiment, method 600 may include adjusting the first percentage weight value and the second percentage weight value based on one or more attributes of an application operating on the first device. In this way, the attributes of the application operating on the first device are taken into consideration when determining the single security profile for the first device in sessions that involve the application operating on the first device. Any suitable attributes of the application may be taken into consideration, such as connections with other peer devices, memory usage, processor usage, variations from normal operating conditions for the application as determined by historical averages of operating parameters, data socket(s) used by the application, first ID associated with the application, second ID associated with the application, OS and container attributes which include server port, transport protocol, NAT IP address range, MTU, application payload sizes, user programmable attributes such as multi-tenancy labels, etc.

In another embodiment, method 600 may include managing actions of the first device in a session with a peer device based on the single security profile for the first device. All actions of the first device may be managed (e.g., allowed, disallowed, modified to be performed in accordance with predetermined security measures, etc.) to some degree, such as data socket usage, communications with peer devices, memory access and allocation, processor usage, etc.

In one embodiment, the first percentage weight (% wt1) is at least twice the second percentage weight (% wt2), e.g., 100%=3*% wt2 and % wt1=2*% wt2+A, where A is a percentage ranging from 0% to 97%, depending on the value of % wt2. Moreover, in this embodiment, the first threat assessment application is an EPPA and the second threat assessment application is an ADPL statistic risk profiler.

Furthermore, when the first threat assessment application is an EPPA, the method 600 may include assigning a programmable percentage probability value for each type of threat detectable by the EPPA, determining which types of the detectable threats are detected according to the first scan results, and summing programmable percentage probability values of all detected threats to determine a severity percentage considered for threats to the first device. The types of detectable threats that the EPPA is able to detect include, but are not limited to, malware, a virus, rogue security software (software that is not authorized to operate as security software on the first device), a Trojan horse, malicious spyware, a computer worm, a botnet, incidences of spam (that are greater than some predetermined threshold), incidences of phishing (that are greater than some predetermined threshold), a rootkit, and an outdated version of the EPPA. In this embodiment, the programmable percentage probability value for each type of threat detectable by the EPPA is adjustable based on one or more attributes of an application operating on the first device. The same or different attributes described above may be considered.

In another embodiment, method 600 may include obtaining a plurality of additional scan results of security threat scans of the first device using a plurality of additional threat assessment applications. These additional scan results may be provided by the ADPL, the EPPA, or some other security threat assessment application known in the art and deployable in the network. Moreover, method 600 may include allocating a plurality of additional percentage weight values individually to each of the additional scan results (in addition to the percentage weights assigned to the first and second scan results). In this embodiment, addition of the first percentage weight, the second percentage weight, and the plurality of additional percentage weight values totals 100%.

According to another embodiment, the single security profile for the first device may be shared with other peer devices in the network on a per application and on the per session basis. In this way, each peer device is apprised of the security profile of the first device, and may adjust its own communication and sharing features to protect itself from any perceivable threats present on the first device.

Method 600 may be implemented as a system, process, or a computer program product. For example, a system may include a processing circuit and logic integrated with and/or executable by the processing circuit. The processing circuit is a non-transitory hardware device configured to execute logic embedded therein, or provided thereto. Examples of processing circuits include, but are not limited to, CPUs, ASICs, FPGAs, microprocessors, integrated circuits, etc. The logic is configured to cause the processing circuit to perform method 600, in one embodiment.

In another example, a computer program product may include a computer readable storage medium having program instructions stored thereon. The computer readable storage medium is a non-transitory device configured to store program instructions that are executable and/or readable by a processing circuit. The program instructions are executable by a processing circuit to cause the processing circuit to perform method 600 in one embodiment.

Variations of the systems, methods, and computer program products described herein are also possible, and the explicit description thereof in this document is not required in order to provide those of skill in the art with the ability to conceive of such variations when reading the present descriptions.

What is claimed is:

1. A method, comprising:
obtaining first scan results of a security threat scan of a first device using a first threat assessment application;
obtaining second scan results of a security threat scan of the first device using a second threat assessment application; and
combining the first scan results and the second scan results to produce a single security profile for the first device on a per session basis.

2. The method as recited in claim 1, further comprising:
allocating a first percentage weight value to the first scan results; and
allocating a second percentage weight value to the second scan results,
wherein addition of the first percentage weight and the second percentage weight totals 100%.

3. The method as recited in claim 2, further comprising:
adjusting the first percentage weight value and the second percentage weight value based on one or more attributes of an application operating on the first device; and
managing actions of the first device in a session with a peer device based on the single security profile for the first device.

4. The method as recited in claim 2, wherein the first percentage weight is at least twice the second percentage weight, wherein the first threat assessment application is an end point protection agent (EPPA), and wherein the second threat assessment application is an Application and Data Protection Layer (ADPL) statistic risk profiler.

5. The method as recited in claim 2, wherein the first threat assessment application is an end point protection agent (EPPA), the method further comprising:
assigning a programmable percentage probability value for each type of threat detectable by the EPPA;
determining which types of the detectable threats are detected according to the first scan results; and
summing programmable percentage probability values of all detected threats to determine a severity percentage considered for threats to the first device.

6. The method as recited in claim 5, wherein the types of detectable threats comprise:
malware;
a virus;
rogue security software;
a Trojan horse;
malicious spyware;
a computer worm;
a botnet;
incidences of spam;
incidences of phishing;
a rootkit; and
an outdated version of the EPPA, and
wherein the programmable percentage probability value for each type of threat detectable by the EPPA is adjustable based on one or more attributes of an application operating on the first device.

7. The method as recited in claim 1, further comprising:
obtaining a plurality of additional scan results of security threat scans of the first device using a plurality of additional threat assessment applications;
allocating a first percentage weight value to the first scan results;
allocating a second percentage weight value to the second scan results; and
allocating a plurality of additional percentage weight values individually to each of the additional scan results,
wherein addition of the first percentage weight, the second percentage weight, and the plurality of additional percentage weight values totals 100%.

8. The method as recited in claim 1, further comprising:
sharing the single security profile for the first device with other peer devices in a network on a per application and on the per session basis.

9. A system, comprising:
a processing circuit and logic integrated with and/or executable by the processing circuit, the logic being configured to cause the processing circuit to:
obtain first scan results of a security threat scan of a first device using a first threat assessment application;
obtain second scan results of a security threat scan of the first device using a second threat assessment application; and
combine the first scan results and the second scan results to produce a single security profile for the first device on a per session basis.

10. The system as recited in claim 9, wherein the logic is further configured to cause the processing circuit to:
allocate a first percentage weight value to the first scan results; and
allocate a second percentage weight value to the second scan results,
wherein addition of the first percentage weight and the second percentage weight totals 100%.

11. The system as recited in claim 10, wherein the logic is further configured to cause the processing circuit to:
adjust the first percentage weight value and the second percentage weight value based on one or more attributes of an application operating on the first device;
manage actions of the first device in a session with a peer device based on the single security profile for the first device; and
share the single security profile for the first device with other peer devices in a network on a per application and on the per session basis.

12. The system as recited in claim 10, wherein the first percentage weight is at least twice the second percentage weight, wherein the first threat assessment application is an end point protection agent (EPPA), and wherein the second threat assessment application is an Application and Data Protection Layer (ADPL) statistic risk profiler.

13. The system as recited in claim 10, wherein the first threat assessment application is an end point protection agent (EPPA), and wherein the logic is further configured to cause the processing circuit to:
assign a programmable percentage probability value for each type of threat detectable by the EPPA;
determine which types of the detectable threats are detected according to the first scan results; and
sum programmable percentage probability values of all detected threats to determine a severity percentage considered for threats to the first device.

14. The system as recited in claim 13, wherein the types of detectable threats comprise:
malware;
a virus;
rogue security software;
a Trojan horse;
malicious spyware;
a computer worm;
a botnet;
incidences of spam;
incidences of phishing;
a rootkit; and
an outdated version of the EPPA, and
wherein the programmable percentage probability value for each type of threat detectable by the EPPA is adjustable based on one or more attributes of an application operating on the first device.

15. The system as recited in claim 9, wherein the logic is further configured to cause the processing circuit to:
obtain a plurality of additional scan results of security threat scans of the first device using a plurality of additional threat assessment applications;
allocate a first percentage weight value to the first scan results;
allocate a second percentage weight value to the second scan results; and
allocate a plurality of additional percentage weight values individually to each of the additional scan results,
wherein addition of the first percentage weight, the second percentage weight, and the plurality of additional percentage weight values totals 100%.

16. A computer program product, comprising a computer readable storage medium having program instructions stored thereon, the program instructions being executable by a processing circuit to cause the processing circuit to:
obtain, by the processing circuit, first scan results of a security threat scan of a first device using a first threat assessment application;
obtain, by the processing circuit, second scan results of a security threat scan of the first device using a second threat assessment application;
combine, by the processing circuit, the first scan results and the second scan results to produce a single security profile for the first device on a per session basis;
manage, by the processing circuit, actions of the first device in a session with a peer device based on the single security profile for the first device; and
share, by the processing circuit, the single security profile for the first device with other peer devices in a network on a per application and on the per session basis.

17. The computer program product as recited in claim 16, wherein the program instructions further cause the processing circuit to:
allocate, by the processing circuit, a first percentage weight value to the first scan results;
allocate, by the processing circuit, a second percentage weight value to the second scan results; and
adjust, by the processing circuit, the first percentage weight value and the second percentage weight value based on one or more attributes of an application operating on the first device,
wherein addition of the first percentage weight and the second percentage weight totals 100%,
wherein the first percentage weight is at least twice the second percentage weight,
wherein the first threat assessment application is an end point protection agent (EPPA), and
wherein the second threat assessment application is an Application and Data Protection Layer (ADPL) statistic risk profiler.

18. The computer program product as recited in claim 17, wherein the first threat assessment application is an end point protection agent (EPPA), and wherein the program instructions further cause the processing circuit to:
assign, by the processing circuit, a programmable percentage probability value for each type of threat detectable by the EPPA;
determine, by the processing circuit, which types of the detectable threats are detected according to the first scan results; and
sum, by the processing circuit, programmable percentage probability values of all detected threats to determine a severity percentage considered for threats to the first device.

19. The computer program product as recited in claim 18, wherein the types of detectable threats comprise:
malware;
a virus;
rogue security software;
a Trojan horse;
malicious spyware;
a computer worm;
a botnet;
incidences of spam;
incidences of phishing;
a rootkit; and
an outdated version of the EPPA, and
wherein the programmable percentage probability value for each type of threat detectable by the EPPA is adjustable based on one or more attributes of an application operating on the first device.

20. The computer program product as recited in claim 16, wherein the program instructions further cause the processing circuit to:
obtain, by the processing circuit, a plurality of additional scan results of security threat scans of the first device using a plurality of additional threat assessment applications;
allocate, by the processing circuit, a first percentage weight value to the first scan results;
allocate, by the processing circuit, a second percentage weight value to the second scan results; and
allocate, by the processing circuit, a plurality of additional percentage weight values individually to each of the additional scan results,
wherein addition of the first percentage weight, the second percentage weight, and the plurality of additional percentage weight values totals 100%.
